(19) United States
(12) Patent Application Publication
(10) Pub. No.: US 2014/0138110 A1
(43) Pub. Date: May 22, 2014

(54) MULTI PURPOSE MANUAL MIXING AND TILLING TOOL

(71) Applicant: Robert Winston Corbett, Woodland, WA (US)

(72) Inventor: Robert Winston Corbett, Woodland, WA (US)

(21) Appl. No.: 13/866,031

(22) Filed: Apr. 19, 2013

Related U.S. Application Data
(60) Provisional application No. 61/675,759, filed on Jul. 25, 2012.

(51) Int. Cl. A01B 1/14; B01F 13/00

(52) U.S. Cl. CPC A01B 1/14; B01F 13/0033
USPC 172/379; 366/129

(57) ABSTRACT

The multipurpose manual mixing and tilling tool, consisting of two elongated manipulating handles attached to opposingly hinged jaw members, each having a plurality of offset and optionally intermeshing tines makes use of manipulating actions that are ergonomically performed to accomplish the task of manual mixing or tilling especially for mixing in vessels such as a bucket, or for manual mixing of materials in vessels that have a deep volume requiring ability to easily reach and integrate the bottom layers. The resulting invention has also proven to be effective and useful as a garden type implement for tilling or loosening soil and such use is a further object of the present invention.

### TECHNICAL FIELDS

The present invention relates to manual tools for the mixing of materials in which powder or aggregated material are added to fluids and mixed into a batch of suitable use. A further field of use relates to manual tools for tilling, or loosening of soil.

### SUMMARY OF THE INVENTION

The object of the present invention is to provide a manual mixing tool designed to minimize effort, and work ergonomically especially for mixing in vessels that are commonly available for use and/or are useful for transport of mixed materials such as a bucket, or for manual mixing of such materials in vessels that have a deep volume requiring ability to reach and integrate the bottom layers. The resulting invention has also proven to be effective and useful as a garden type implement for tilling or loosening soil and such use is a further object of the present invention.

The foregoing objectives are achieved according to this invention by provision of a mixing head comprising two opposing jaw members having multiple tines offset so as to allow intermeshing, such jaw members being hinged so as to allow pivoting in relation to each other by means of manipulating two elongated handles which also allow for lifting or inserting the head through the material being mixed or tilled.

### BRIEF DESCRIPTION OF THE DRAWINGS

FIG. 1 is a perspective view of a multi-purpose manual mixing tool in assembled condition according to the present invention.

FIG. 2 is an illustrated view of the mixing head illustrating the pivoting movement, and the optional offset tine intermeshing capability.

### EXEMPLORY DESCRIPTION FOR CARRYING OUT THE INVENTION

It can be seen from the figures and descriptions herein that the multi-purpose manual mixing and tilling tool provides a tool designed to minimize effort and alleviate worker fatigue by making use of design and manipulating actions that are ergonomically performed to accomplish the task of mixing or tilling. Those skilled in the art can appreciate that when mixing small batches of material such as concrete mix, mortar or stucco and especially in deeper containers such as a bucket there is a need for a hand held mixing tool which easily and rapidly mixes the material using the appropriate amount of water. The multi-purpose manual mixing and tilling tool is designed to alleviate worker fatigue while accomplishing the rapid mixing by the following actions, and methods of use.

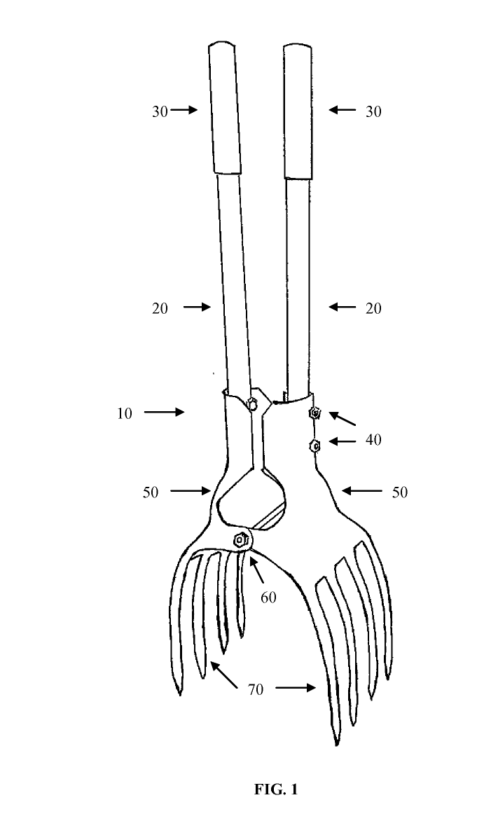

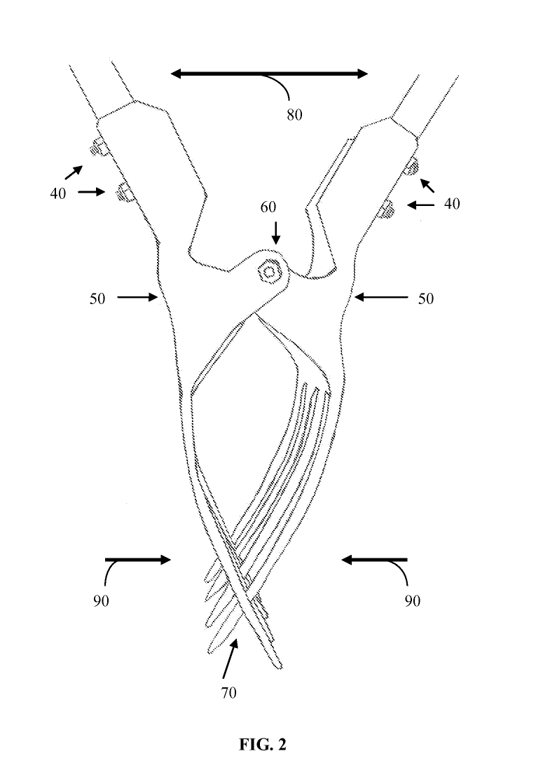

Referring to FIGS. 1 AND 2, the tool 10, includes two tubular handles 20, with grips 30, bolted 40, to opposing jaw members 50, hinge bolted 60, having offset tines 70, allowing for spreading or converging of handles 80, which pivots the jaws to open or close 90.

The designed advantages of the tool include the following. The tines are designed to reduce the friction of insertion and retraction thereby making it easier to reach through to deeper material. The vertical cavities produced by the piercing of the tines allow paths for hydraulic integration of fluids due to natural gravitational head pressure of the fluids. The tines may be designed to intermesh offset with the opposing tines thereby inducing hydraulic plasticity of the material while shredding large drier clods. Alternately the tines may be designed to directly offset the opposing tine where this proves more functional for the use than intermeshing tines. The tines are designed to reach to the bottom edge of the vertical sides of mixing containers thereby making the complete mixing of vessel contents possible. The tines exert a griping force when the jaws are partially closed thereby allowing for material to be lifted through the mixture. The jaws can be partially closed upon insertion through the material thereby producing a mashing force though the material. The offset forces of exertion on the material minimize container torque thereby minimizing effort to stabilize the container. The proximity of use to the user minimizes efforts associated with reaching or dragging. The manipulating actions are designed to work easily with normal human body movements.

The envisioned preferred method for mixing includes the following. First add ⅔ of the fluid ingredients (water or admixture) to the container. Pour ⅔ of the dry material through the fluids. Mix the initial portion of the batch. Remove the tool and add the remaining dry material. Pour the remaining fluid over the batch. Mix with the tool using the appropriate combination of the afore-described actions.

It is noted that the embodiment of the multi-purpose manual mixing and tilling tool described in detail for exemplary purposes is subject to many different variations in structure, design, application or methodology within the scope of the inventive concept(s) herein taught. Because many varying and different embodiments may be made in the embodiment herein detailed in accordance with the descriptive requirements of the law, it is to be understood that the details herein are to be interpreted as illustrative and not in a limiting sense.

I claim:

1. A multipurpose manual mixing and tilling tool, comprising:
a) two manipulating tubular handles with grips attached to,
b) a mixing head having two jaw members fixed together by means of a hinge so as to oppose each other with like actions,
c) having a plurality of tines vertically positioned and aligned with opposing tines on opposing jaw member to optimize manipulation effort and rapid mixing or tilling effect.

2. The multipurpose manual mixing and tilling tool of claim 1 wherein further the tines are offset with the opposing tines of the opposing jaw member to provide for the intermeshing of said tines to further produce hydraulic induction into or shredding of the material.

3. The multipurpose manual mixing and tilling tool of claim 1 with further specific configuration modification and/or component shape modification to adapt it to specific characteristics such as granular or aggregate size, viscosity, cohesion, plasticity or fluidness of specific materials.

4. The multipurpose manual mixing and tilling tool of claim 1 with further specific modifications of size or material component to adapt it for specific use such as food grade, medical, commercial, industrial, or individual.
